(19) United States
(12) Patent Application Publication
(10) Pub. No.: US 2014/0376134 A1
(43) Pub. Date: Dec. 25, 2014

(54) Voltage Protection Circuit

(71) Applicant: TEXAS INSTRUMENTS INCORPORATED, Dallas, TX (US)

(72) Inventors: Bradford Lawrence Hunter, Spicewood, TX (US); Richard David Nicholson, Aptos, CA (US)

(21) Appl. No.: 13/921,598

(22) Filed: Jun. 19, 2013

(51) Int. Cl. H02H 9/04

(52) U.S. Cl. CPC H02H 9/044
USPC 361/56; 361/88

(57) ABSTRACT

In an integrated circuit device having an internal circuitry that requires voltage protection (e.g. negative voltage protection), the voltage protection is provided by a FET. In some embodiments, the source and drain of the FET are connected in series with the internal circuitry and an I/O node through which the voltage can be received (e.g. the source connected to the internal circuitry and the drain connected to the I/O node). In some embodiments, the FET is drain-extended (e.g. a drain-extended PFET).

### BACKGROUND OF THE INVENTION

Within many types of integrated circuit (IC) chips, the lowest potential, or ground voltage, is typically applied to the substrate of the IC die, e.g. through power-related I/O pins. However, there are some circumstances in which a voltage within such an IC chip may go below ground, i.e. a negative voltage. For example, IC chip components may experience a negative voltage when power supply connections to the IC chip are accidentally applied backwards, when an external ground connection breaks or during a negative electrostatic discharge (ESD), among other potential situations. (If an external supply voltage can reach 50V, for example, then a −50V protection is commonly required for an accidental reverse connection.) Additionally, in some situations, the voltage may even exceed a proper positive voltage level, e.g. during a positive ESD.

Such improper voltage levels, whether positive or negative, can cause problems for some of the components or structures in the IC chip. An improper voltage level, in some situations, may simply cause the IC chip not to operate properly, but in other situations, can irreparably damage the IC chip. It is therefore often necessary to include sufficient voltage protection circuitry within many types of IC chips.

It is with respect to these and other background considerations that the present invention has evolved.

### SUMMARY OF THE INVENTION

In some embodiments, the present invention involves an integrated circuit device that has an internal circuitry, an I/O node and a FET. The internal circuitry requires voltage protection. A voltage can be received through the I/O node. The FET is connected between the I/O node and the internal circuitry to provide the voltage protection for the internal circuitry. A source and a drain of the FET are in series with the I/O node and the internal circuitry.

In some embodiments, the present invention involves an integrated circuit device that has an internal circuitry, an I/O node and a drain-extended FET. The internal circuitry requires protection from a voltage. A voltage can be received through the I/O node. The drain-extended FET provides the protection from the voltage.

In some embodiments, the present invention involves a method comprising receiving a voltage at a drain of a FET in an integrated circuit device, the FET passing almost all of the voltage through a source of the FET to an internal circuitry of the integrated circuit device when the voltage is positive, and the FET preventing almost all of the voltage from passing to the internal circuitry when the voltage is negative. The internal circuitry requires protection from negative voltage.

A more complete appreciation of the present disclosure and its scope, and the manner in which it achieves the improvements described herein, can be obtained by reference to the following detailed description of presently preferred embodiments taken in connection with the accompanying drawings, which are briefly summarized below, and the appended claims.

### BRIEF DESCRIPTION OF THE DRAWINGS

FIG. 1 is a simplified schematic diagram of an example electronic circuit incorporating an embodiment of the present invention.

FIG. 2 is a simplified cross section of a drain-extended PFET for use in the example electronic circuit shown in FIG. 1 in accordance with an embodiment of the present invention.

FIG. 3 is a table of example data showing the performance of the example electronic circuit shown in FIG. 1 in accordance with an embodiment of the present invention.

### DETAILED DESCRIPTION OF THE INVENTION

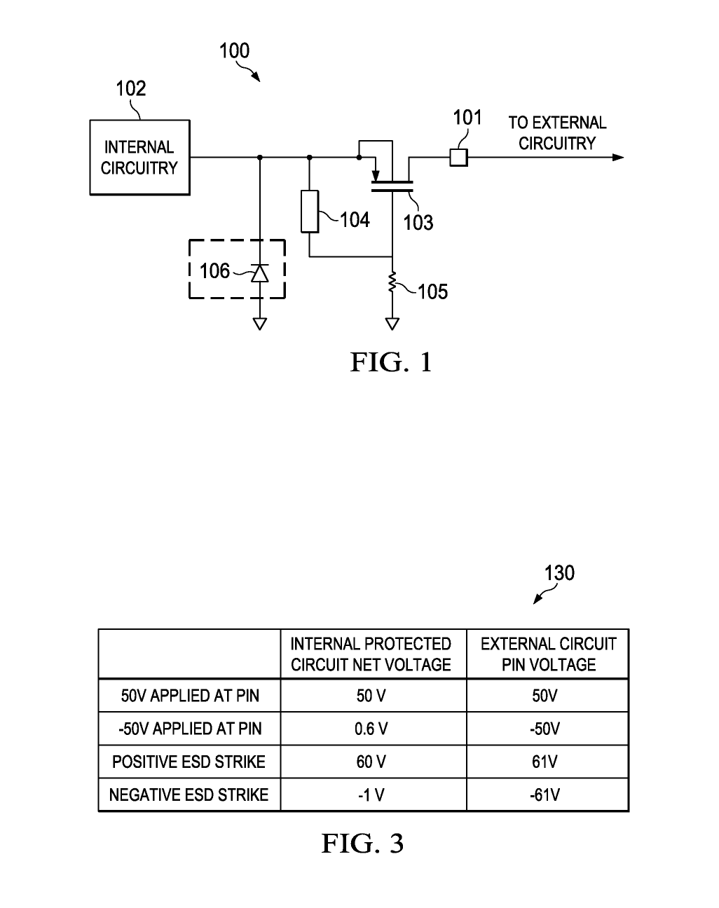

An example of an electronic circuit 100 incorporating an embodiment of the present invention is shown in FIG. 1. The electronic circuit 100 generally represents at least part of an overall IC device or chip. Additionally, the illustrated embodiment of the electronic circuit 100 generally includes an I/O (input/output) node, pin or pad 101, an internal circuitry 102, a FET 103, a voltage clamp 104, a limiting resistor 105 and an ESD structure 106. Additional components may also be included, but are not shown for simplicity.

The I/O node 101 is any appropriate type of connection point to other electronic circuits external to the electronic circuit 100, e.g. an IC package pin. The electronic circuit 100 may receive a voltage, intentionally or accidentally, through the I/O node 101. The internal circuitry 102 generally represents any appropriate circuit components that perform any portion of the general functions of the overall IC device, such as, but not limited to, the functions of power management IC applications. The internal circuitry 102 generally requires protection from improper voltage levels (positive and/or negative) that may be received through the I/O node 101. The remainder of the illustrated components 103-106 provides the required voltage protection as described below.

In some embodiments, the FET 103 is a drain-extended FET, such as a drain-extended PFET, or PMOS device. High voltage analog CMOS processes, for example, often offer drain-extended devices for 50V support and beyond. In other embodiments, however, the FET 103 may be a PFET without the drain-extension, although the embodiments with drain extension may allow the FET 103 to be substantially smaller. Additionally, some embodiments are characterized by having the drain and source of the FET 103 connected in series between the I/O node 101 and the internal circuitry 102, with the drain of the FET 103 connected to the I/O node 101 and the source of the FET 103 connected to the internal circuitry 102 as shown. Still other embodiments, however, may even adapt an NFET to do essentially the same function described herein for the FET 103.

The voltage clamp 104 may be any appropriate type of device through which no (or almost no) current flows until the voltage drop across the device reaches a predetermined voltage level, at which point the device goes from being an open (or almost an open) circuit to a short (or almost a short) circuit. For example, the voltage clamp 104 may be a Zener diode or a FET. In the illustrated embodiment, the voltage clamp 104 is connected between the gate and source of the FET 103 to clamp the gate-source voltage to the predetermined voltage level. In some embodiments (e.g. some embodiments in which the FET 103 is a PFET without the drain-extension), the voltage clamp 104 may be unnecessary or optional.

Additionally, the limiting resistor 105 can be implemented in a variety of ways, such as with FETs, depletion mode devices or almost any kind of load structure that could provide a short to ground until the voltage clamp 104 activates. In the illustrated embodiment, the limiting resistor 105 connects the voltage clamp 104 and the gate of the FET 103 to ground. When the voltage clamp 104 activates, the limiting resistor 105 limits the current through the voltage clamp 104.

The ESD structure 106 generally represents any appropriate positive ESD protection cell. Although the ESD structure 106 is shown in the illustrated embodiment as a reverse-biased diode connected from the source of the FET 103 to ground, it understood that other components can be used in place of the ESD structure 106 for generally the same function described herein. In some embodiments, any standard positive protection ESD cell of the appropriate voltage tolerance can be interfaced with the FET 103.

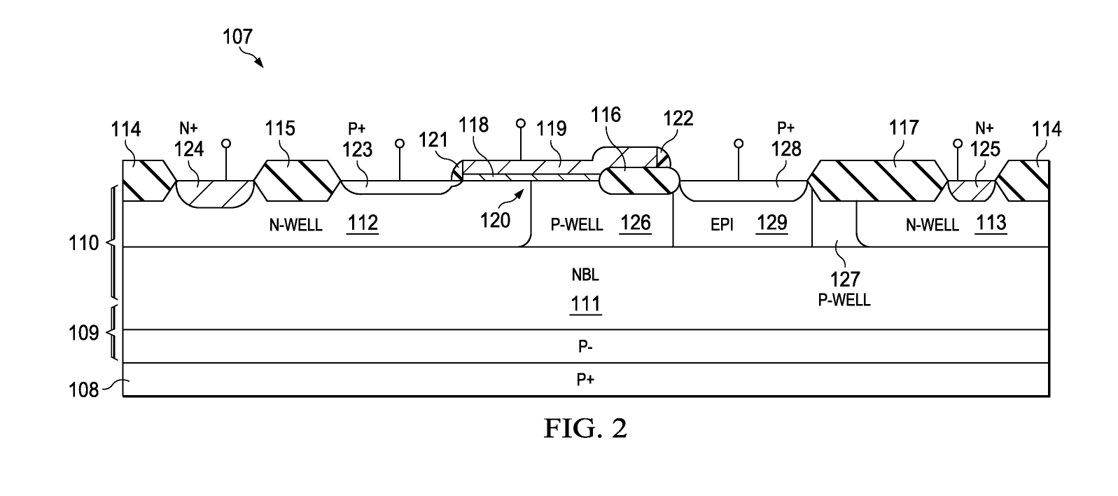

The FET 103 can generally interface to any type of internal circuit including power supplies or I/O receivers and drivers. The FET 103 generally operates to ensure that the internal net voltage (i.e. the voltage provided to the internal circuitry 102) is about the same as the external net voltage (i.e. the voltage level at the I/O node 101) from a positive value (e.g. about 30-50V or more or less, depending on the design parameters of the FET 103) to within about the level of a threshold voltage of the FET 103 above ground. Thus, the FET 103 generally allows a voltage level at the I/O node 101 to go negative while preventing the internal circuitry 102 and the ESD structure 106 from receiving all (or almost all) of the negative voltage. For drain-extended PFET embodiments, the drain structure (see FIG. 2 below) allows the drain voltage (i.e. the voltage at the I/O node 101) to go substantially below ground or a substantial voltage level (e.g. 30-50 volts or more or less) below the gate, body and/or source terminals. Thus, an external net voltage below approximately the absolute value of the threshold voltage (Vthp) of the FET 103 will not be reflected on the internal net voltage. According to some embodiments, therefore, a circuit with the FET 103 may be used in applications that need negative voltage tolerance. A drain-extended depletion mode or zero Vthp PFET device can generally provide voltage protection down to or slightly below the voltage level of the substrate of the IC chip (i.e. the ground voltage).

As is common with FETs, the FET 103 has a parasitic body diode between its drain and its body. The p side of the diode connects to the drain, and the n side connects to the body. Under normal operation, when the body diode is forward biased, current flows through the FET 103. When the external voltage at the I/O node 101 is zero, the gate turns off the FET 103. As the voltage starts to climb, all the current goes through the body diode until the voltage at the I/O node 101 rises above the threshold voltage of the FET 103. When the voltage at the I/O node 101 rises above about a volt, the limiting resistor 105 holds the gate of the FET 103 to ground, and the FET 103 turns on. When the voltage at the I/O node 101 rises above about two volts, the body diode is shorted out by the channel of the FET 103 so the current travels through the FET channel. Additionally, if the voltage at the I/O node 101 falls to between ground and the break down voltage of the FET 103, the FET 103 prevents the negative voltage from reaching the internal circuitry 102.

The FET 103 is generally self protecting against ESD strikes, and the FET 103 can carry both positive and negative ESD currents. Thus, the FET 103 serves as an ESD protection structure in addition to performing regular I/O functions.

A negative ESD strike generally equalizes to ground through the FET 103 (in reverse break down) and the ESD structure 106 (as a forward biased diode). The size of the FET 103 is generally large enough to carry the ESD current under break down conditions and not sustain damage. (In general, PFETs are relatively good at breaking down and reliably carrying an ESD current without sustaining damage.) Once the voltage goes sufficiently negative to cause the FET 103 to break down, the FET 103 and the ESD structure 106 generally behave like a standard I/O structure with a standard ESD diode. An appropriately designed PFET, for example, will reliably break down as long as the current does not exceed a certain maximum level (e.g. about 2-4 Amps) for a maximum period of time. Since an ESD strike may occur for only about 2 microseconds, then as long as the PFET can carry the ESD current without becoming damaged, it should just break down naturally to protect against the ESD strike, and then it will go back to operating in a normal way.

In a positive ESD strike situation, on the other hand, the FET 103 operates in the forward direction, so the positive ESD strike equalizes to ground through the body diode of the FET 103 and the ESD structure 106. Again, the FET 103 is generally designed to be big enough to carry the ESD current for the relatively short duration of the strike (e.g. about 2 microseconds), so that the body diode is not damaged. Additionally, the ESD structure 106 generally has a break down voltage, like a Zener diode or grounded gate NMOS device. With an ESD strike in the forward direction, therefore, the ESD structure 106 conducts the current to ground when the ESD voltage level exceeds the break down voltage level for which it is designed, thereby protecting the internal circuitry 102 from the ESD strike.

The voltage clamp 104 generally protects the oxide of the FET 103 at relatively high positive external voltages. Additionally, the limiting resistor 105 generally limits the current through the voltage clamp 104, so the voltage clamp 104 does not present a hard short to ground during the high positive external voltages. Thus, the voltage clamp 104 protects the gate-to-source voltage of the FET 103, since the gate-to-source does not have the high voltage capability of the drain in drain-extended embodiments. The voltage clamp 104 is designed, therefore, so that the voltage at which the voltage clamp 104 begins to conduct is at about the maximum allowable gate-to-source voltage of the FET 103. In non-drain-extended embodiments, on the other hand, the voltage clamp 104 may be unnecessary or optional.

An example of a drain-extended PFET 107 that in some embodiments may be used as the FET 103 in the example electronic circuit 100 of FIG. 1 is shown in FIG. 2. (Other embodiments may use other structures for the FET 103.) The drain-extended PFET 107 provides particular advantages in applications requiring high breakdown voltage withstanding capabilities, such as in the FET 103, for example. The drain-extended PFET 107 is formed in a composite semiconductor body 108, 109 and 110, beginning with a p-doped silicon substrate 108 (P+), where a lower epitaxial silicon 109 (P− lower epi) is formed over the substrate 108, and a p-type upper epitaxial silicon 110 (upper epi) is formed over the lower EPI 109. The drain-extended PFET 107 may be fabricated in any type of semiconductor body 108-110, including but not limited to semiconductor (e.g., silicon) wafers, silicon-over-insulator (SOI) wafers, epitaxial layers in a wafer, or other composite semiconductor bodies, etc., wherein the present invention and the appended claims are not limited to the illustrated structures or materials.

An n-buried layer 111 (NBL) extends into an upper portion of the lower EPI 109 and a lower portion of the upper EPI 110. In the illustrated example, left and right N-WELL regions 112 and 113 are formed in an upper portion of the upper EPI 110. The N-WELL regions 112 and 113 can generally contain a relatively large voltage with respect to the substrate 108. Additionally, various field oxide (FOX) isolation structures 114-117 are formed to separate different terminals of the drain-extended PFET 107 from one another and from other components in the drain-extended PFET 107, although other isolation techniques may be used (e.g., shallow trench isolation (STI), local oxidation of silicon (LOCOS), etc.).

The drain-extended PFET 107 comprises a gate structure having a thin gate dielectric 118 that underlies a conductive gate electrode 119. The gate electrode 119 further overlays at least a portion of the isolation structure 116. The gate structure 118 and 119 overlays a channel region 120 in the upper EPI 110. In some embodiments, therefore, the separation between the gate electrode 119 and the channel region 120 goes from a relatively small thickness (e.g. about 80 Angstroms) at the gate dielectric 118 to a relatively large thickness (e.g. about 20 microns) at the isolation structure 116.

The gate structure 118 and 119 is abutted by a left sidewall spacer 121 along a left lateral side and a right sidewall spacer 122 along a right lateral side. A p-type source 123 is formed in the semiconductor body within left N-WELL region 112. Similarly, left and right n-type backgates 124, 125 are formed within left and right N-WELL regions 112 and 113, respectively. The source 123 has left and right laterally opposite sides, with the right lateral side located along a left lateral side of the channel 120 proximate the left lateral side of the gate structure 118 and 119, where the left opposite side of the source 123 is separated from the left backgate 124 by the isolation structure 115.

A split P-WELL having left and right regions 126 and 127 is also formed in an upper portion of the upper EPI 110. The P-WELL regions 126 and 127 are generally fully isolated inside the N-WELL regions 112 and 113. A p-type drain 128 formed in the semiconductor body overlays a region 129 of the upper EPI 110 that is abutted by the left and right P-WELL regions 126 and 127. The channel region 120 underlying the gate structure 118 and 119 is thereby established within some of the left N-WELL region 112 and some of the left split P-WELL region 126. The p-type drain 128 is spaced from the right side of the gate structure 118 and 119 to provide an extended drain, wherein the n-buried layer 111 is situated in the upper and lower epitaxial silicon layers 110 and 109 beneath at least a portion of the gate structure 118 and 119 and the drain 128.

In some embodiments, the drain-extended PFET 107 is similar to one or more structures shown in U.S. Pat. No. 7,262,471, which is assigned to the same assignee as the present invention. Therefore, additional description for such embodiments may be found therein, and the disclosure of U.S. Pat. No. 7,262,471 is hereby incorporated by reference as if fully set forth herein.

A table 130 shows example data illustrating the performance of an example embodiment of the electronic circuit 100 shown in FIG. 1. The table 130 shows four possible conditions for the internal protected circuit net voltage (i.e. voltage provided to the internal circuitry 102) and the external circuit pin voltage (i.e. voltage at the I/O node 101).

For this example, the electronic circuit 100 is assumed to be part of a power management IC application, wherein under normal operating conditions the electronic circuit 100 is connected to receive about 50 volts at the I/O node 101 and the FET 103 is designed to provide about 50 volts to the internal circuitry 102, as shown in the first row of the table 130.

Since the expectation is for the voltage at the I/O node 101 to be positive 50 volts, there is the possibility for this voltage to accidentally be negative 50 volts, e.g. if power supply connections to the electronic circuit 100 were accidentally applied backwards. In this situation, the internal circuitry 102 receives about 0.6 volts, as shown in the second row of the table 130, because the threshold voltage of the FET 103 generally turns off the FET 103 under this condition.

The third row of the table 130 illustrates the effect of an example positive ESD strike at the I/O node 101. In this example, the voltage at the I/O node 101 is assumed to reach about 61 volts and the break down voltage of the ESD structure 106 is assumed to be about 60 volts. The internal circuitry 102, therefore, receives about 60 volts, since about one volt is lost to the body diode of the FET 103.

The fourth row of the table 130 illustrates the effect of an example negative ESD strike at the I/O node 101. In this example, the ESD strike at the I/O node 101 is assumed to reach about negative 61 volts and the break down voltage of the FET 103 is assumed to be about negative 60 volts. The internal circuitry 102, therefore, receives about negative one volt, since the FET 103 breaks down at negative 60 volts and the ESD structure 106 is generally designed to clamp at negative one volt.

Presently preferred embodiments of the present invention and its improvements have been described with a degree of particularity. This description has been made by way of preferred example. It should be understood, however, that the scope of the claimed subject matter is defined by the following claims, and should not be unnecessarily limited by the detailed description of the preferred embodiments set forth above.

The invention claimed is:

1. An integrated circuit device comprising:
an internal circuitry requiring voltage protection;
an I/O node through which a voltage can be received; and
a FET connected between the I/O node and the internal circuitry to provide the voltage protection for the internal circuitry, a source and a drain of the FET being in series with the I/O node and the internal circuitry.

2. The integrated circuit device of claim 1, wherein:
the FET is a drain-extended FET.

3. The integrated circuit device of claim 1, wherein:
the drain of the FET is connected to the I/O node and the source of the FET is connected to the internal circuitry.

4. The integrated circuit device of claim 3, further comprising:
a voltage clamp connected between the source and a gate of the FET to limit a gate-source voltage for the FET.

5. The integrated circuit device of claim 3, further comprising:
an ESD protection cell connected to the source of the FET.

6. The integrated circuit device of claim 1, wherein:
the FET is a PFET.

7. The integrated circuit device of claim 1, wherein:
the FET provides negative voltage protection for the internal circuitry.

8. An integrated circuit device comprising:
an internal circuitry requiring protection from a voltage;
an I/O node through which the voltage can be received; and
a drain-extended FET that provides the protection from the voltage.

9. The integrated circuit device of claim 8, wherein:
the drain-extended FET is a PFET.

10. The integrated circuit device of claim 8, wherein:
the drain-extended FET provides a negative voltage protection.

11. The integrated circuit device of claim 8, wherein:
a source and a drain of the drain-extended FET are connected in series between the internal circuitry and the I/O node.

12. The integrated circuit device of claim 11, further comprising:
the drain of the FET is connected to the I/O node and the source of the FET is connected to the internal circuitry.

13. The integrated circuit device of claim 12, further comprising:
a voltage clamp connected between the source and a gate of the drain-extended FET to limit a gate-source voltage for the drain-extended FET.

14. The integrated circuit device of claim 12, further comprising:
an ESD protection cell connected to the source of the drain-extended FET.

15. A method comprising:
in an integrated circuit device, receiving a voltage at a drain of a FET;
the FET passing almost all of the voltage through a source of the FET to an internal circuitry of the integrated circuit device when the voltage is positive, the internal circuitry requiring protection from negative voltage; and
the FET preventing almost all of the voltage from passing to the internal circuitry when the voltage is negative.

16. The method of claim 15, wherein:
the FET is a drain-extended FET.

17. The method of claim 15, wherein:
the drain of the FET is connected to an I/O node of the integrated circuit device and the source of the FET is connected to the internal circuitry.

18. The method of claim 15, further comprising:
clamping a voltage between the source and a gate of the FET to limit a gate-source voltage for the FET.

19. The method of claim 15, wherein:
an ESD protection cell is connected to the source of the FET.

20. The method of claim 15, wherein:
the FET is a PFET.
